(19) United States
(12) Patent Application Publication
(10) Pub. No.: US 2006/0188164 A1
(43) Pub. Date: Aug. 24, 2006

(54) Apparatus and method for predicting coefficients of video block

(75) Inventors: Sang-rae Lee, Suwon-si (KR); Jeong-hoon Park, Seoul (KR); Seung-ran Park, Hwaseong-si (KR); So-young Kim, Yongin-si (KR); Yu-mi Sohn, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/281,583

(22) Filed: Nov. 18, 2005

(30) Foreign Application Priority Data
Feb. 18, 2005 (KR) 10-2005-0013517

(51) Int. Cl. G06K 9/36

(52) U.S. Cl. 382/238

(57) ABSTRACT

An apparatus and method are provided for predicting coefficients of a video block. The method, includes determining a predicted value of a DC coefficient of a current block using DC coefficients of a plurality of previous blocks that are adjacent to the current block and determining predicted values of a plurality of AC coefficients of the current block using AC coefficients of the plurality of previous blocks, independently of the determination of the predicted value of the DC coefficient of the current block.

### CROSS-REFERENCE TO RELATED PATENT APPLICATION

This application claims priority from Korean Patent Application No. 10-2005-0013517, filed on Feb. 18, 2005, in the Korean Intellectual Property Office, the disclosure of which is incorporated herein in its entirety by reference.

### BACKGROUND OF THE INVENTION 1. Field of the Invention

Apparatuses and methods consistent with the present invention relate to encoding of video data, and more particularly, to predicting coefficients of a video block.

2. Description of the Related Art

Since video contains a large amount of data, compression encoding is essential for storage or transmission of video data. Encoding or decoding of video data is performed in data units such as macroblocks of 16×16 pixels or blocks of 4×4 pixels. To encode or decode video data in units of a predetermined block, pixels included in a picture should be scanned.

FIG. 1 illustrates a conventional raster scan scheme. According to a conventional raster scan scheme, pixels included in a picture are scanned left-to-right and top-to-bottom. Thus, raster scanning begins with a pixel at the top-left corner of a picture.

As one of video data compression methods, there is intra spatial prediction. Intra spatial prediction is a technique for compressing video data using similarities among data in one picture.

According to Moving Picture Expert Group (MPEG)-4 Part 2, one of the international standards for moving picture compression, after a current block undergoes discrete cosine transform (DCT), its DC and AC coefficients are predicted using coefficients of neighboring blocks of the current block.

FIG. 2 is a view for explaining prediction of a DC coefficient of a current block according to MPEG-4 Part 2. Referring to FIG. 2, to predict a DC coefficient of a current block X 4, previous blocks A 3, B 1, and C 2 are used. According to raster scanning as shown in FIG. 1, pixels included in a picture are scanned left-to-right and top-to-bottom. Thus, the previous blocks A 3, B 1, and C 2 are already scanned and encoded or decoded prior to the current block X 4. The previous blocks 3, B 1, and C 2 and the current block X 4 are 8×8 blocks.

Hereinafter, prediction of the DC coefficient of the current block X 4 according to MPEG-4 Part 2 will be described.

A difference between a DC coefficient 30 of the previous block A 3 and a DC coefficient 10 of the previous block B 1 and a difference between a DC coefficient 20 of the previous block C 2 and a DC coefficient 10 of the previous block B 1 are calculated. If the difference between the DC coefficient 30 and the DC coefficient 10 is smaller than the difference between the DC coefficient 20 and the DC coefficient 10, the previous block A3 and the previous block B 1 may be regarded as having a similar video characteristic therebetween. Moreover, the current block X 4 and the previous block C 2 may be regarded as being similar to each other. This is because a DC coefficient of a block is the average of pixels of the block. Thus, the previous block C 2 is determined to be a reference block for prediction of the DC coefficient 40 of the current block X 4, and the coefficient 20 of the previous block C 2 is determined to be a prediction value of the DC coefficient 40 of the current block X 4. However, if the difference between the DC coefficient 30 and the DC coefficient 10 is larger than the difference between the DC coefficient 20 and the DC coefficient 10, the previous block A 3 is determined to be a reference block for prediction of the DC coefficient 40 of the current block X 4, and the DC coefficient 30 of the previous block A 3 is determined to be a predicted value of the DC coefficient 40 of the current block X 4. Once a predicted value of the DC coefficient 40 of the current block X 4 is determined, a difference between the DC coefficient 40 and the predicted value thereof is entropy-encoded and transmitted to a decoder or stored in a storage medium.

If one of the previous blocks A 3, B 1, and C 2 is located outside a video object plane (VOP) or is not an intra block, the predicted value of the DC coefficient 40 of the current block X 4 is determined to be a predetermined value, e.g., 1024. A VOP is a kind of video unit for video coding and decoding specified in MPEG-4 Part 2, and one video frame is divided into a plurality of VOPs and is encoded or decoded in units of a VOP.

Upon completion of prediction of the DC coefficient 40 of the current block X 4, prediction of AC coefficients of the current block X 4 is performed using a result of the prediction of the DC coefficient 40. In other words, the AC coefficients of the current block X 4 are predicted using the DC coefficient 30 of the previous block A 3 or the DC coefficient 20 of the previous block C 2 that is determined to be a reference block for prediction of the DC coefficient 40 of the current block X 4.

FIGS. 3 and 4 are views for explaining prediction of the AC coefficients of the current block X 4 according to MPEG-4 Part 2.

FIG. 3 is a view for explaining prediction of the AC coefficients of the current block X 4 when the previous block C 2 is used as a reference block for prediction of the DC coefficient 20 of the current block X 4. According to MPEG-2 Part 2, when the previous block C 2 is used as a reference block for prediction of the DC coefficient 20 of the current block X 4, AC coefficients 21 through 27 included in the first row of the previous block C 2 are determined to be predicted values of AC coefficients 41 through 47 included in the first row of the current block X 4. For example, the AC coefficient 21 of the previous block C 2 is a predicted value of the AC coefficient 41 of the current block X 4 and the AC coefficient 22 of the previous block C 2 is a predicted value of the AC coefficient 42 of the current block X 4. Other AC coefficients except for the AC coefficients 41 through 47 included in the first row of the current block X 4 are entropy-encoded without prediction.

FIG. 4 is view for explaining prediction of the AC coefficients of the current block X 4 when the previous block A 3 is used as a reference block for prediction of the DC coefficient 20 of the current block X 4. According to MPEG-2 Part 2, when the previous block A 3 is used as a reference block for prediction of the DC coefficient 20 of the current block X 4, AC coefficients 31 through 37 included in the first column of the previous block C 2 are determined to be predicted values of AC coefficients 51 through 57 included in the first column of the current block X 4. For example, the AC coefficient 31 of the previous block A 3 is a predicted value of the AC coefficient 51 of the current block X 4 and the AC coefficient 32 of the previous block A 3 is a predicted value of the AC coefficient 52 of the current block X 4. Other AC coefficients except for the AC coefficients 51 through 57 included in the first column of the current block X 4 are entropy-encoded without prediction.

In the case of prediction of AC and DC coefficients of a current block according to MPEG-4 Part 2, the AC coefficients of the current block are predicted using a reference block determined for prediction of the DC coefficient of the current block. In other words, prediction of the AC coefficients of the current block is performed in the same direction as prediction of the DC coefficient of the current block.

However, a plurality of non-zero AC coefficients may be generated depending on a distribution pattern of pixels of a block. In other words, in some cases, it may not be preferable that the AC coefficients of the current block are predicted in the same direction as prediction of the DC coefficient of the current block. As a result, accuracy in prediction of AC coefficients is degraded, causing degradation in encoding and decoding efficiency.

### SUMMARY OF THE INVENTION

The present invention provides an apparatus and method for predicting coefficients of a video block, in which AC coefficients of a current block are predicted independently of prediction of a DC coefficient of the current block, thereby improving accuracy in prediction of the AC coefficients.

The present invention also provides a computer-readable recording medium having recorded thereon a program for implementing a method of predicting coefficients of a video block which improves accuracy in prediction of AC coefficients of a current block.

According to an aspect of the present invention, there is provided a method of predicting coefficients of a video block. The method comprises determining a predicted value of a DC coefficient of a current block using DC coefficients of a plurality of previous blocks that are adjacent to the current block and determining predicted values of a plurality of AC coefficients of the current block using AC coefficients of the plurality of previous blocks, independently of the determination of the predicted value of the DC coefficient of the current block.

According to another aspect of the present invention, there is provided an apparatus for predicting coefficients of a video block. The apparatus comprises a memory and a prediction unit. The memory stores DC coefficients and AC coefficients of a plurality of previous blocks that are adjacent to a current block. The prediction unit determines a predicted value of a DC coefficient of the current block using the DC coefficients of the plurality of previous blocks stored in the memory and determines predicted values of AC coefficients of the current block using the AC coefficients of the plurality of previous blocks, independently of the determination of the predicted value of the DC coefficient of the current block.

According still another aspect of the present invention, there is provided a computer-readable recording medium having recorded thereon a program for implementing a method of predicting coefficients of a video block, the method comprising determining a predicted value of a DC coefficient of a current block using DC coefficients of a plurality of previous blocks that are adjacent to the current block and determining predicted values of a plurality of AC coefficients of the current block using AC coefficients of the plurality of previous blocks, independently of the determination of the predicted value of the DC coefficient of the current block.

### BRIEF DESCRIPTION OF THE DRAWINGS

The above and other aspects of the present invention will become more apparent by describing in detail exemplary embodiments thereof with reference to the attached drawings in which:

FIG. 1 illustrates a conventional raster scan scheme;

FIG. 2 is a view for explaining prediction of a DC coefficient of a current block according to MPEG-4 Part 2;

FIGS. 3 and 4 are views for explaining prediction of AC coefficients of the current block according to MPEG-4 Part 2;

FIG. 5 is a block diagram of a video data encoder according to an exemplary embodiment of the present invention;

FIG. 6 is a block diagram of an apparatus for predicting coefficients of a video block according to an exemplary embodiment of the present invention;

FIG. 7 is a flowchart illustrating a method of predicting coefficients of a video block according to an exemplary embodiment of the present invention;

FIG. 8 is a detailed flowchart illustrating operation S330 of FIG. 7; and

FIG. 9 is a block diagram of a video data decoder according to an exemplary embodiment of the present invention.

### DETAILED DESCRIPTION OF EXEMPLARY EMBODIMENTS OF THE INVENTION

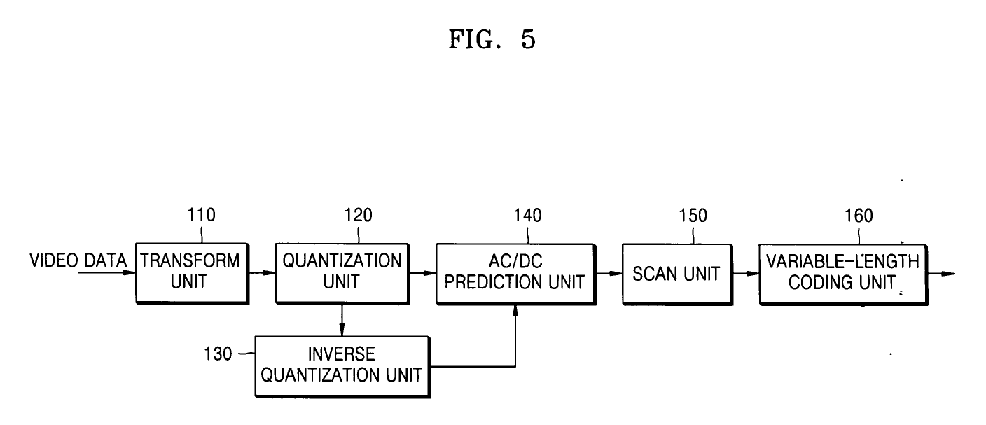

FIG. 5 is a block diagram of a video data encoder according to an exemplary embodiment of the present invention. Referring to FIG. 5, the video data encoder according to an exemplary embodiment of the present invention includes a transform unit 110, a quantization unit 120, an inverse quantization unit 130, an AC/DC prediction unit 140, a scan unit 150, and a variable-length coding unit 160.

The transform unit 110 receives an input video block of a predetermined size and transforms the input video block using a predetermined method. In this exemplary embodiment of the present invention, the input video block is discrete cosine transformed. When the input video block is an 8×8 block, once the 8×8 input video block is discrete cosine transformed, 1 DC coefficient and 63 AC coefficients are created by the transform unit 110. Although an 8×8 block is taken as an example in this exemplary embodiment of the present invention, the size of the input video block is not limited to 8×8, but may vary such as 4×4.

The quantization unit 120 quantizes coefficients input from the transform unit 110 and outputs the quantized coefficients to the inverse quantization unit 130 and the AC/DC prediction unit 140. The inverse quantization unit 130 inversely quantizes the quantized coefficients and provides results of the inverse quantization to the AC/DC prediction unit 140 for prediction of DC and AC coefficients of a current block.

The AC/DC prediction unit 140 performs prediction of coefficients of a video block according to the present invention and a difference between an original coefficient of a current block and a predicted value of the original coefficient. The configuration and operation of the AC/DC prediction unit 140 will be described in more detail later.

The scan unit 150 scans a difference between an original coefficient of a current block and a predicted value of the original coefficient and/or the original coefficient of the current block in a predetermined order and provides the scanned coefficient(s) to the variable-length coding unit 160. The variable-length coding unit 160 performs variable-length coding on the scanned coefficient(s) to output a bitstream.

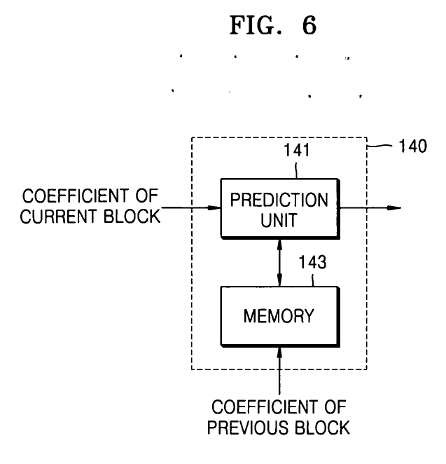

FIG. 6 is a detailed block diagram of the AC/DC prediction unit 140 of FIG. 5. Referring to FIG. 6, the AC/DC prediction unit 140 includes a prediction unit 141 and a memory 143. The memory 143 stores DC coefficients and AC coefficients of a plurality of previous blocks that are adjacent to a current block. According to an exemplary embodiment shown in FIG. 5, the DC coefficients and AC coefficients of the plurality of previous blocks stored in the memory 143 are inversely quantized values. The prediction unit 141 determines predicted values of a DC coefficient and a plurality of AC coefficients of the current block using the DC coefficients and AC coefficients of the plurality of previous blocks stored in the memory 143 and the quantized coefficients of the current block input from the quantization unit 120.

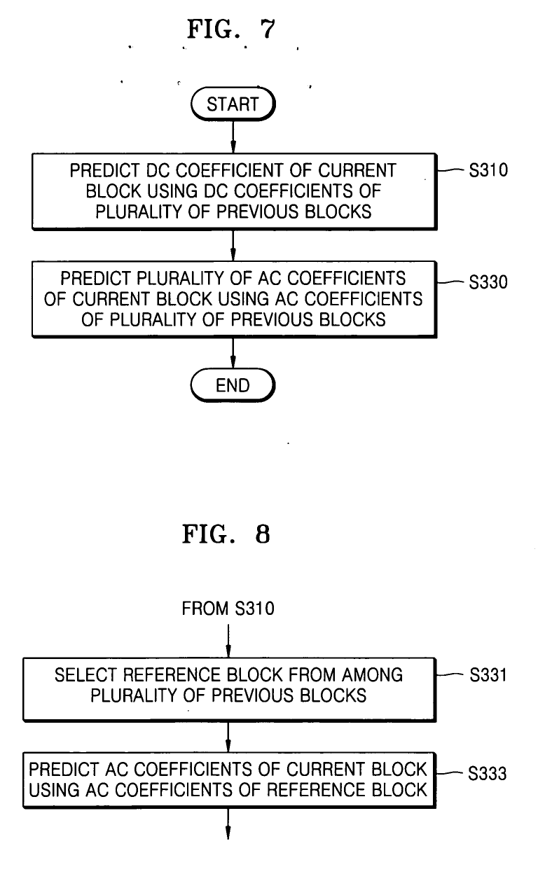

Referring to FIGS. 7 and 8, the operation of the prediction unit 141 will be described in more detail.

In operation S310, the prediction unit 141 determines a predicted value of a DC coefficient of the current block using the DC coefficients of the plurality of previous blocks stored in the memory 143 and the quantized DC coefficient of the current block input from the quantization unit 120. Since prediction of the DC coefficient of the current block is performed using as a well-known prediction method, it will not be described herein.

In operation S330, the prediction unit 141 determines predicted values of the AC coefficients of the current block using the AC coefficients of the plurality of previous blocks stored in the memory 143 and the quantized AC coefficients of the current block input from the quantization unit 120, independently of determination of the predicted value of the DC coefficient of the current block.

FIG. 8 is a detailed flowchart illustrating operation S330 of FIG. 7. Prediction of the AC coefficient of the current block includes determination of a direction of prediction of the AC coefficient and prediction of the AC coefficient. Determination of a direction of prediction of the AC coefficient involves determining a reference block to be used to determine predicted values of the AC coefficients of the current block among the plurality of previous blocks.

Referring to FIG. 8, the prediction unit 141 selects a reference block to be used to determine predicted values of the AC coefficients of the current block from among the plurality of previous blocks in operation S331.

According to the present invention, the AC coefficients of the current block are predicted independently of prediction of the DC coefficient of the current block. In particular, a direction of prediction of the AC coefficients of the current block is separately determined without referring to a direction of prediction of the DC coefficient of the current block.

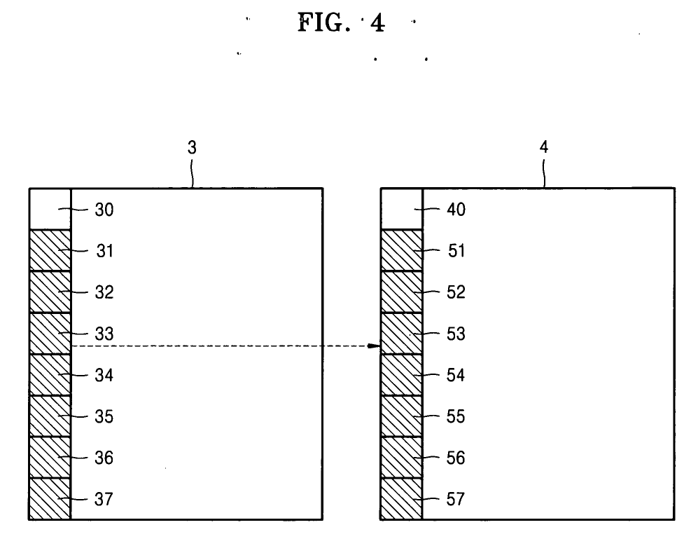

The direction of prediction of the AC coefficients of the current block, i.e., a reference block for prediction of the AC coefficients of the current block, is determined as follows. First, it is assumed that the current block and the plurality of previous blocks are 8×8 blocks and the AC coefficients of the current block are predicted using vertical prediction as shown in FIG. 3 or horizontal prediction as shown in FIG. 4.

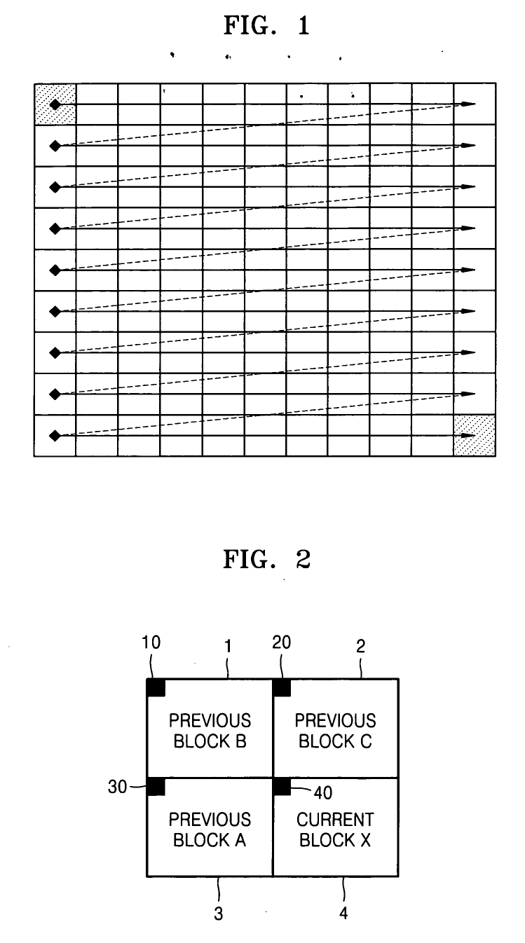

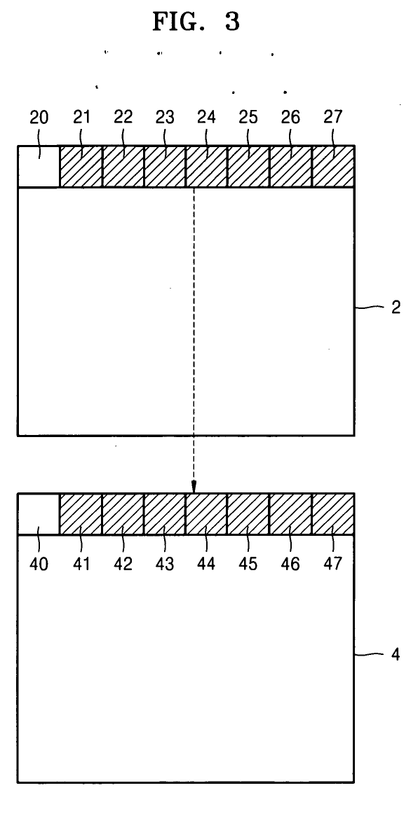

The prediction unit 141 calculate T1 using Equation 1 as follows.

$$T 1 = {\sum }_{i = 1}^{7} {W}_{1} \times \vert {AC}_{A} ( 0 , i ) - {AC}_{B} ( 0 , i ) \vert , \qquad ( 1 )$$

where Wᵢ represents a predetermined weight value, AC_{A} (0, i) represents an AC coefficient in the first column of a previous block A 3 that is adjacent left to the current block X 4 as shown in FIG. 2, and ACB (0, i) represents an AC coefficient in the first column of a previous block B 1 that is adjacent above the previous block A 3. A larger weight value is assigned to a low-frequency AC coefficient that is important for determination of a direction of prediction of AC coefficients. For example, 3 is assigned to a weight value W₁, 2 is assigned to weight values W₂ and W₃, and 1 is assigned to weight values W₄ through W₇. Alternatively, to determine the direction of prediction of the AC coefficients more easily and faster, 1 may be assigned to the weight value W₁ and 0 may be assigned to other weight values. The prediction unit 141 calculates T2 using Equation 2 as follows.

$$T 2 = {\sum }_{i = 1}^{7} {W}_{1} \times \vert {AC}_{ B} ( i , 0 ) - {AC}_{C} ( i , 0 ) \vert , \qquad ( 2 )$$

where AC_{B} (i, 0) represents an AC coefficient in the first row of the previous block B 1, AC_{c} (i, 0) represents an AC coefficient in the first row of a previous block C 2, and Wᵢ represents a predetermined weight value and is preferably set to the same value as that used in Equation 1.

Once T1 and T2 are calculated using Equations 1 and 2, the prediction unit 141 determines which one of T1 and T2 is larger than the other. If T1 is smaller than T2, the previous block A 3 and the previous block B 1 are regarded as having a similar video characteristic. Thus, the previous block C 2 is selected as a reference block for prediction of the AC coefficients of the current block X 4. On the other hand, if T1 is larger than T2, the previous block A 3 is selected as a reference block for prediction of the AC coefficients of the current block X 4.

Once a reference block to be used for prediction of the AC coefficients of the current block is selected in operation S331, predicted values of the AC coefficients of the current block are determined using AC coefficients of the selected reference block in operation S333. Prediction of the AC coefficients of the current block is performed using as a well-known prediction method. In other words, the AC coefficients of the current block are predicted using vertical prediction as shown in FIG. 3 or horizontal prediction as shown in FIG. 4.

Since coefficients of the previous blocks stored in the memory 1413 are inversely quantized values, predicted values of the coefficients of the current block are also inversely quantized values. The coefficients of the current block that are input to the prediction unit 141 are quantized values. Thus, the predicted values of the coefficients of the current block should be quantized again.

A description has been made regarding the apparatus and the method for predicting coefficients of a video block according to an exemplary embodiment of the present invention in terms of the video data encoder shown in FIG. 5. Similarly, the apparatus for and the method of predicting coefficients of a video block according to an exemplary embodiment of the present invention can also be applied to a decoder.

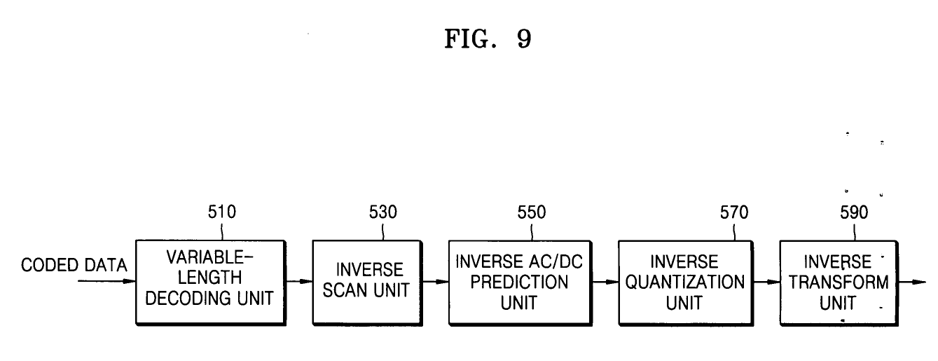

FIG. 9 is a block diagram of a video data decoder according to an exemplary embodiment of the present invention. The video data decoder of FIG. 9 decodes the video data which is encoded by the video data encoder of FIG. 5. Referring to FIG. 9, the video data decoder according to an exemplary embodiment of the present invention includes a variable-length decoding unit 510, an inverse scan unit 530, an inverse AC/DC prediction unit 550, an inverse quantization unit 570, and an inverse transform unit 590. The variable-length decoding unit 510, the inverse scan unit 530, the inverse AC/DC prediction unit 550, the inverse quantization unit 570, and the inverse transform unit 590 performs inverse operations with respect to the variable-length coding unit 160, the scan unit 150, the AC/DC prediction unit 140, the quantization unit 120, and the transform unit 110 of the video data encoder shown in FIG. 5. The inverse AC/DC prediction unit 550 is an apparatus for predicting coefficients of a video block according to another exemplary embodiment of the present invention and its detailed operation is similar to the AC/DC prediction unit 140 shown in FIG. 6 except that the input and output of the AC/DC prediction unit 140 are the output and input of the inverse AC/DC prediction unit 550, respectively.

As described above, according to the present invention, AC coefficients of a current block are predicted independently of prediction of a DC coefficient of the current block, thereby improving accuracy in prediction of the AC coefficients and thus improving encoding and decoding efficiency.

The method of predicting coefficients of a video block according to an exemplary embodiment of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of predicting coefficients of a video block, the method comprising:
determining a predicted value of a DC coefficient of a current block using DC coefficients of a plurality of previous blocks that are adjacent to the current block; and
determining predicted values of a plurality of AC coefficients of the current block using AC coefficients of the plurality of previous blocks, independently of the determining of the predicted value of the DC coefficient of the current block.

2. The method of claim 1, wherein the determining of the predicted values of the plurality of AC coefficients of the current block comprises:
selecting a reference block from among the plurality of previous blocks; and
determining the predicted values of the plurality of AC coefficients of the current block using AC coefficients of the selected reference block.

3. The method of claim 2, wherein the selecting of the reference block comprises selecting a previous block having a video characteristic that is similar to a video characteristic of the current block as the reference block from between a first previous block located the left of the current block or a second previous block located above the current block.

4. The method of claim 3, wherein the selecting of the reference block comprises comparing at least one AC coefficient of the first previous block and at least one AC coefficient of a third previous block located above the first previous block and comparing at least one AC coefficient of the second previous block and at least one AC coefficient of the third previous block to select the reference block.

5. The method of claim 4, wherein the selecting of the reference block comprises comparing a difference between an AC coefficient of the first previous block and an AC coefficient of the third previous block corresponding to the AC coefficient of the first previous block and a difference between an AC coefficient of the second previous block and an AC coefficient of the third previous block corresponding to the AC coefficient of the second previous block to select the reference block.

6. The method of claim 4, wherein the selecting of the reference block comprises comparing a sum of differences between a plurality of AC coefficients of the first previous block and a plurality of AC coefficients of the third previous block corresponding to the plurality of AC coefficients of the first previous block and a sum of differences between a plurality of AC coefficients of the second previous block and a plurality of AC coefficients of the third previous block corresponding to the plurality of AC coefficients of the second previous block to select the reference block.

7. The method of claim 6, wherein the selecting of the reference block comprises comparing a sum of differences between AC coefficients of the first previous block and the third previous block and a sum of differences between AC coefficients of the second previous block and the third previous block to select the reference block, each difference being multiplied by a predetermined weight value.

8. The method of claim 1, wherein the DC coefficients and AC coefficients of the plurality of previous blocks are inversely quantized values.

9. The method of claim 1, wherein the current block and the plurality of previous blocks are 8×8 blocks or 4×4 blocks.

10. An apparatus for predicting coefficients of a video block, the apparatus comprising:
a memory which stores DC coefficients and AC coefficients of a plurality of previous blocks that are adjacent to a current block; and
a prediction unit which determines a predicted value of a DC coefficient of the current block using the DC coefficients of the plurality of previous blocks stored in the memory, and determines predicted values of AC coefficients of the current block using the AC coefficients of the plurality of previous blocks, independently of the determination of the predicted value of the DC coefficient of the current block.

11. The apparatus of claim 10, wherein the prediction unit selects a reference block from among the plurality of previous blocks and determines the predicted values of the plurality of AC coefficients of the current block using AC coefficients of the selected reference block.

12. The apparatus of claim 11, wherein the prediction unit selects a previous block having a video characteristic that is similar to a video characteristic of the current block as the reference block from between a first previous block located to the left of the current block or a second previous block located above the current block.

13. The apparatus of claim 12, wherein the prediction unit compares at least one AC coefficient of the first previous block and at least one AC coefficient of a third previous block located above the first previous block and comparing at least one AC coefficient of the second previous block and at least one AC coefficient of the third previous block to select the reference block.

14. The apparatus of claim 13, wherein the prediction unit compares a difference between an AC coefficient of the first previous block and an AC coefficient of the third previous block corresponding to the AC coefficient of the first previous block and a difference between an AC coefficient of the second previous block and an AC coefficient of the third previous block corresponding to the AC coefficient of the second previous block to select the reference block.

15. The apparatus of claim 13, wherein the prediction unit compares a sum of differences between a plurality of AC coefficients of the first previous block and a plurality of AC coefficients of the third previous block corresponding to the plurality of AC coefficients of the first previous block and a sum of differences between a plurality of AC coefficients of the second previous block and a plurality of AC coefficients of the third previous block corresponding to the plurality of AC coefficients of the second previous block to select the reference block.

16. The apparatus of claim 15, wherein the prediction unit compares a sum of differences between AC coefficients of the first previous block and the third previous block and a sum of differences between AC coefficients of the second previous block and the third previous block to select the reference block, each difference being multiplied by a predetermined weight value.

17. The apparatus of claim 10, wherein the DC coefficients and AC coefficients of the plurality of previous blocks are inversely quantized values.

18. The apparatus of claim 10, wherein the current block and the plurality of previous blocks are 8×8 blocks or 4×4 blocks.

19. A computer-readable recording medium having recorded thereon a program for implementing a method of predicting coefficients of a video block, the method comprising:
determining a predicted value of a DC coefficient of a current block using DC coefficients of a plurality of previous blocks that are adjacent to the current block; and
determining predicted values of a plurality of AC coefficients of the current block using AC coefficients of the plurality of previous blocks, independently of the determining of the predicted value of the DC coefficient of the current block.

20. The computer-readable recording medium of claim 19, wherein the determining of the predicted values of the plurality of AC coefficients of the current block comprises:
selecting a reference block from among the plurality of previous blocks; and
determining the predicted values of the plurality of AC coefficients of the current block using AC coefficients of the selected reference block.

21. The computer-readable recording medium of claim 20, wherein the selecting of the reference block comprises selecting a previous block having a video characteristic that is similar to a video characteristic of the current block as the reference block from between a first previous block located to the left of the current block or a second previous block located above the current block.

22. The computer-readable recording medium of claim 21, wherein the selecting of the reference block comprises comparing at least one AC coefficient of the first previous block and at least one AC coefficient of a third previous block located above the first previous block and comparing at least one AC coefficient of the second previous block and at least one AC coefficient of the third previous block to select the reference block.

23. The computer-readable recording medium of claim 22, wherein the selecting of the reference block comprises comparing a difference between an AC coefficient of the first previous block and an AC coefficient of the third previous block corresponding to the AC coefficient of the first previous block and a difference between an AC coefficient of the second previous block and an AC coefficient of the third previous block corresponding to the AC coefficient of the second previous block to select the reference block.

24. The computer-readable recording medium of claim 22, wherein the selecting of the reference block comprises comparing a sum of differences between a plurality of AC coefficients of the first previous block and a plurality of AC coefficients of the third previous block corresponding to the plurality of AC coefficients of the first previous block and a sum of differences between a plurality of AC coefficients of the second previous block and a plurality of AC coefficients of the third previous block corresponding to the plurality of AC coefficients of the second previous block to select the reference block.

25. The computer-readable recording medium of claim 24, wherein the selecting of the reference block comprises comparing a sum of differences between AC coefficients of the first previous block and the third previous block and a sum of differences between AC coefficients of the second previous block and the third previous block to select the reference block, each difference being multiplied by a predetermined weight value.
